(19) United States
(12) Patent Application Publication
(10) Pub. No.: US 2025/0315757 A1
(43) Pub. Date: Oct. 9, 2025

(54) AI-BASED ALLOCATION OF WILDFIRE MANAGEMENT RESOURCES

(71) Applicant: Team Wildfire Inc., Boulder, CO (US)

(72) Inventor: Stephen Wolf, Boulder, CO (US)

(21) Appl. No.: 18/630,213

(22) Filed: Apr. 9, 2024

(51) Int. Cl. G06Q 10/0631; A62C 3/02

(52) U.S. Cl. CPC G06Q 10/06315; A62C 3/02

(57) ABSTRACT

A system for generation of wildfire suppression asset allocation based on wildfire-related data, including a processor of a fire analysis server (FAS) node configured to host a machine learning (ML) module and connected to at least one fire surveillance device and to at least one command-and-control entity node over a wireless network and a memory on which are stored machine-readable instructions that when executed by the processor, cause the processor to: acquire sensory data from a plurality of sensors hosted on the at least one fire surveillance device; parse the sensory data to derive a plurality of key features; acquire available fire suppression assets'-related data from a local storage; query a local fires'-related database to retrieve local historical fires'-related data related to previous fires' suppression engagements based on the plurality of the key features and available fire suppression assets'-related data; generate at least one feature vector based on the plurality of key features, the available fire suppression assets'-related data and the local historical fires'-related data; and provide the at least one feature vector to the ML module configured to generate a predictive model for producing asset allocation parameters for generation of the assets' deployment plan for the at least one least one command-and-control entity node.

### FIELD OF DISCLOSURE

The present disclosure generally relates to wildfire management based on collected data, and more particularly, to an AI-based automated system for real-time allocation of wildfire management and suppression resources based on predictive analytics of wildfire-related data.

### BACKGROUND

The process of real-time allocation of wildfire suppression resources such as equipment, water, personnels, etc. is commonly used by fire unit commanders.

Wildfires represent one of the most catastrophic, destructive and urgent threats faced on this planet. With ecosystems at stake, economies in jeopardy, and lives on the line, traditional firefighting approaches, strategies and tactics often fall short, in the face of intensifying and erratic fire behavior. In particular, inaccurate requesting and allocation of fire suppression equipment by unit commanders based on educated guesses could cause rapid fire spread and higher losses and prolonged mitigation efforts.

There are many software-based systems that incorporate data to predict fire movements and intensity. However, these systems leave it to the commander to figure out how to act on that information. Existing wildfire mitigation command and control systems do not provide for automated accurate real-time wildfire assessments for recommendation of required fire suppression equipment.

Accordingly, a system and method for automated real-time AI-based allocation of wildfire management and suppression resources based on predictive analytics of wildfire-related data are desired.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One embodiment of the present disclosure provides a system for generation of wildfire suppression asset allocation based on wildfire-related data, including a processor of a fire analysis server (FAS) node configured to host a machine learning (ML) module and connected to at least one fire surveillance device and to at least one command-and-control entity node over a wireless network and a memory on which are stored machine-readable instructions that when executed by the processor, cause the processor to: acquire sensory data from a plurality of sensors hosted on the at least one fire surveillance device; parse the sensory data to derive a plurality of key features; acquire available fire suppression assets'-related data from a local storage; query a local fires'-related database to retrieve local historical fires'-related data related to previous fires' suppression engagements (including fire parameters data and the resource allocation data) based on the plurality of the key features and available fire suppression assets'-related data; generate at least one feature vector based on the plurality of key features, the available fire suppression assets'-related data and the local historical fires'-related data; and provide the at least one feature vector to the ML module configured to generate a predictive model for producing asset allocation parameters for generation of the assets' deployment plan for the at least one least one command-and-control entity node.

Another embodiment of the present disclosure provides a method that includes one or more of: acquiring sensory data from a plurality of sensors hosted on the at least one fire surveillance device; parsing the sensory data to derive a plurality of key features; acquiring available fire suppression assets'-related data from a local storage; querying a local fires'-related database to retrieve local historical fires'-related data related to previous fires' suppression engagements based on the plurality of the key features and available fire suppression assets'-related data; generating at least one feature vector based on the plurality of key features, the available fire suppression assets'-related data and the local historical fires'-related data; and providing the at least one feature vector to the ML module configured to generate a predictive model for producing asset allocation parameters for generation of the assets' deployment plan for the at least one least one command-and-control entity node.

Another embodiment of the present disclosure provides a computer-readable medium including instructions for acquiring sensory data from a plurality of sensors hosted on the at least one fire surveillance device; parsing the sensory data to derive a plurality of key features; acquiring available fire suppression assets'-related data from a local storage; querying a local fires'-related database to retrieve local historical fires'-related data related to previous fires' suppression engagements based on the plurality of the key features and available fire suppression assets'-related data; generating at least one feature vector based on the plurality of key features, the available fire suppression assets'-related data and the local historical fires'-related data; and providing the at least one feature vector to the ML module configured to generate a predictive model for producing asset allocation parameters for generation of the assets' deployment plan for the at least one least one command-and-control entity node.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A illustrates a network diagram of a system for an AI-based automated real-time allocation of wildfire management and suppression resources and assets based on predictive analytics of wildfire-related data consistent with the present disclosure;

FIG. 1B illustrates a network diagram of a system for an AI-based automated real-time allocation of wildfire management and suppression resources and assets based on predictive analytics of wildfire-related data implemented over a blockchain consistent with the present disclosure;

FIG. 2 illustrates a network diagram of a system including detailed features of a fire analysis server (FAS) node consistent with the present disclosure;

FIG. 3A illustrates a flowchart of a method for an AI-based automated real-time allocation of wildfire management and suppression resources based on predictive analytics of wildfire-related data consistent with the present disclosure;

FIG. 3B illustrates a further flowchart of a method for AI-based automated real-time allocation of wildfire management and suppression resources based on predictive analytics of wildfire-related data consistent with the present disclosure;

FIG. 4 illustrates deployment of a machine learning model for prediction of asset allocation-related parameters using blockchain assets consistent with the present disclosure;

FIG. 5 illustrates a block diagram of a system including a computing device for performing the method of FIGS. 3A and 3B.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Regarding applicability of 35 U.S.C. § 112, 16, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in the context of the sepsis diagnosis, embodiments of the present disclosure are not limited to use only in this context.

The present disclosure provides a system, method and computer-readable medium for AI-based automated real-time allocation of wildfire management and suppression resources including equipment, water resources and personnel based on predictive analytics of wildfire-related data. In one embodiment, the system overcomes the limitations of existing fire mitigation methods by employing fine-tuned models derived from pre-trained predictive models irrespective of data format, style, or data type. By leveraging the capabilities of the pre-trained predictive models, the disclosed approach offers a significant improvement over existing solutions discussed above in the background section.

In one embodiment of the present disclosure, the system provides for AI and machine learning (ML)-generated parameters based on analysis of a wildfire-related data. In one embodiment, an automated decision/recommendation model may be generated to provide for fire suppression equipment usage and allocation recommendation parameters associated with the current filed fire situation. The automated decision/recommendation model may use historical fires' data collected at the current location (i.e., an annual seasonal wildfire site) and at wildfire sites facilities of the same type located within a certain range from the current location or even located globally. The relevant fires' data may include data related to other fires and equipment employed having the same parameters such as size, location, weather conditions, fire parameters, etc. The relevant fires' data may indicate successfully mitigated wildfire cases and indication of equipment used for wildfire mitigation and the location(s) where the successful mitigation/suppression was performed. This way, the best matching set of equipment may be assigned to respond to a given wildfire site based on current fire-related data and historical data of mitigation of wildfires having the same characteristics such as size, intensity, rate of spreading, ambient conditions, location, etc.

In one disclosed embodiment, the AI/ML technology may be combined with a blockchain technology for secure use of the wildfire-related data and wildfire-related surveillance data. In one embodiment, the fire analysis entities (e.g., unmanned vehicles, drones, etc.) may be connected to the fire analysis server (FAS) node over a blockchain network to achieve a consensus prior to executing a transaction to release the asset allocation recommendations for the current wildfire site based on the asset allocation recommendation parameters produced by the AI/ML module. The system may utilize asset allocation-related data based on the fire analysis and the fire command-and-control entities being on-boarded to the system via a blockchain network.

In contrast to the existing software-based systems that incorporate data to predict fire movement, leaving it to the user to figure out how to act on that information, the wildfire command system application described herein may be configured to take this information further to formulate actionable suppression strategies based on available firefighting resources, and priorities. The wildfire command system may further be configured to un-silo accumulated fire knowledge and data that resides in hundreds of independent disjointed data sources, such as government agencies, universities, among others, and integrate it into a single source of actionable information and maximally informed suppression plans.

In various embodiments, a wildfire command system comprises one or more of an advanced pyrotechnic-informed, sensor-integrated, dynamic AI-driven decision support system for superior real time wildfire management and suppression.

In one embodiment, the wildfire command system includes or incorporates one or more sensors. For example, the wildfire command system may be configured to integrate inputs from a plurality of sensors. In one example, the wildfire command system comprises a sensor input module configured for comprehensive sensor input integration. The sensor input module may integrate inputs from a multiplicity of sensors. In one configuration, the sensors input module may be configured to dynamically select sensors for data queries. Each sensor may be selected and calibrated for its potential to provide valuable insights into wildfire behavior. Additionally, sensors may be selected for their potential to provide insights that the wildfire command system uses to alert users to additional hazards. The wildfire command system may be configured to integrate data feeds from an unlimited number of individual or clustered sensors, including but not limited to all or any combination of, including any known or future developed sensors, selected from location inputs, including those of satellite navigation systems, such as global navigation satellite systems, e.g., global positioning system (GPS); environmental sensors configured to measure environmental conditions such as wind speed, wind direction, ambient temperature, humidity, barometric pressure, or ultraviolet radiation exposure; geographic conditions such as ground slope angle and its orientation relative to the sun; biota or ecological sensors such as vegetation moisture probes, vegetative density sensors, vegetation type identifiers, or soil moisture probes; optical sensors such as high resolution video feeds, infrared cameras and sensors, or high resolution still imagery cameras; acoustic sensors; gas analyzers or chemical detectors, including any combination of, but not limited to: O2, O3, CO, CO2, NO, NO2, H2SO4, chlorine compounds, propane, methane, benzene, acrolein, polycyclic aromatic hydrocarbons (PAHs), volatile organic compounds (VOCs), hydrogen cyanide (HCN), sulfur dioxide (SO₂), ammonia (NH₃), particulate matter (PM2.5 and PM10) or other chemicals that may be present at, released or diminished by wildfire activity; air quality monitors; radiation detectors; microwave radiometry; radar systems, such as doppler, soil composition sensors; electromagnetic field (EMF) sensors; motion sensors; ground vibration monitors, thermal radiometers, lightning detection devices; or decibel meters. The wildfire command system may comprise or utilized inputs for integration obtained by LIDAR systems, HADAR systems, satellite imagery, data input from specialized fire movement & behavior programs, external POI maps, or topographic data, including any combination thereof.

The wildfire command system may comprise an analysis module configured to analyze inputs, which may be utilized by the wildfire command system to generate outputs as described herein. In some embodiments, the analysis module comprises AI submodule. In this or another embodiment, the analysis module comprises a data analytics submodule. The analysis module may include one or more machine learning (ML) algorithms. The algorithms may incorporate supervised, unsupervised, and reinforcement learning frameworks. The algorithms may be employed to ensure accurate wildfire spread predictions, potential shifts in behavior, enable modeling of optimal suppression actions, or combination thereof. The analysis module may be configured with computer vision techniques for application to inputs. The computer vision techniques may include capabilities spanning object detection, segmentation, real-time video analytics, crucial for early fire detection and trend prediction, or the like. The analysis module may be configured to perform dynamic data processing. The processing may includer rapid processing and real-time analytics of data from diverse sources to ensure up-to-the-moment insights. The analysis module may employ continuous learning mechanisms. For example, the analysis module may be configured with AI models that adapt and refine their predictive accuracies and strategic recommendations based on incoming data streams and previously integrated models. In one embodiment, the analysis module includes or is configured to utilize quantum computing. For example, delineated segments of a suppression plan may be routed to quantum computing resources for analysis and processing, with their outputs then plugged back into the AI.

The wildfire command system may be configured with an adaptive strategy design for data analysis an output generation. For example, AI models may be informed by physics, chemistry, meteorological, pyrotechnic, and other insights, and trained on vast amounts of prior fire-data to speedily craft strategic plans for containment and suppression that are both dynamic and scientifically rigorous. In one configuration, the wildfire command system is configured with real time adaptability. For example, the wildfire command system may be configured for immediate recalibration and re-issuance of suppression strategies based on continuously evolving fire conditions. In this or another configuration, the wildfire command system is configured for optimal resource deployment. Resource allocation strategies, for instance, may be configured to maximize crew safety, civilian safety, suppression efficacy, and the safeguarding of prioritized assets.

The wildfire command system may be configured with a resource and priority drive response framework. For example, the wildfire command system may actively solicit information about available local and national fire response resources as additional inputs. The wildfire command system may be configured to automatically query such resources. For instance, when used in communities where computer aided dispatch systems are used, the wildfire command system may query these systems automatically to determine what equipment, personnel and other resources are available. The wildfire command system may take inventory of available assets for incorporation in generated response plans. Example inventories of responding agency assets and resources may include one or more of heavy equipment assets such as quantity, type, or both of: heavy equipment, e.g., bulldozers, graders, backhoes, or the like; aerial resources, such as winged aircraft (e.g., fixed wing, spotters, VLATs, etc.), rotary lift aircraft (e.g., helicopters of various capabilities); vehicular assets (e.g., type 1 trucks, type 2 trucks, type 3 trucks, type 4 trucks, type 5 trucks, type 6 trucks, pickup trucks, UTVs, water tenders); marine assets (e.g., type 1 boats, type 2 boats), including any combination thereof. Asset and resource inventories may also include personnel (e.g., command staff, supervisory staff, firefighters, hand crews, specialized crews, drone operators, communications crews, public information officers); water sources (e.g., hydrants, ocean, river, lakes, streams, ponds, swimming pools, storage tanks, water treatment plants); hand tools (e.g., chainsaws, rakes, hoes, axes, drip torches, flappers); team wildfire assets (e.g., hurricane, cloud burse, storm cell, thunder head); UAV/UAS assets (e.g., drones, unmanned helicopters); consumables (e.g., suppressants, retardants, foams, gels, accelerants; support services (e.g., food, lodging, sanitation), or any combination thereof. In some embodiments, the wildfire command system may assess or take inventory of logistical factors, limiting factors, or both such as distance between the fire and water sources, means and availability for transporting water to the fire, time to deliver water from source to destination, calculation of gallons per minute that can be delivered to the fire combining the above data. As stated above, some or all of this list of available fire suppression assets may be prepopulated into an incident's data set by querying the dispatch software of near-by fire agencies, to determine which of that organization's assets are currently deployed elsewhere, and which assets are available.

In some embodiments, the wildfire command system may include an ordered list of values at risk (OLIVAR) module. The OLIVAR module may solicit and incorporate protection priorities as additional inputs. The wildfire command system may utilize protection priorities to calibrate output. For example, the prioritized protection may be used by the analysis module, e.g., AI submodule, to calibrate its out strategies based on the importance of assets at risk. In various embodiments, the assets at risk may include hospitals, schools, residences, transportation infrastructure (e.g., airports, train stations, ports, parking lots, bridges), energy infrastructure such as power plants (e.g., nuclear, wind, hydroelectric), businesses, industrial sites, historical sites, data centers, streams, reservoirs, lakes, military assets (e.g., bases, depots, equipment, installations), among others.

In one embodiment, the wildfire command system includes or communicates with a user interface of a computing device configured to query users with respect to asset protection priorities. In a further or another example, the OLIVAR module may be configured to automatically suggest assets for the user to rank, which may be based on publicly available maps that include “points of interest,” based on a fire's current and anticipated position.

As introduced above, the wildfire command system may be configured to generate outputs. Outputs may be generated and facilitated by an output module based at least in part on analysis data generated by the analysis module. In various embodiments, the output module may generate or facilitate real-time suppression plans, data visualizations, crew allocation and tasking directives, automated assignment of refueling to each vehicular asset, automated routing of water refill trucks, remote commands for interfacing with compatible hardware, feedback loops for suppression strategy refinement, evacuation orders, updated evacuation route planning, supplemental protective measures, automated ordering and delivery of crew meals/water and timing, immediate issuance and detailed emergency instructions for crew evacuations as conditions deteriorate, through an operational framework for uncompromising a compromised crew (OFUCC) module. The operational framework may include or integrate with mechanical frameworks including communications hardware configured to facilitate robust data communication. The output recommendations of the OFUCC module may be reliably delivered via robust and redundant emergency communications hardware to the crew. For robust and uninterrupted data transmission and command relay, the wildfire command system may interface with state-of-the-art communications hardware, such as redundant satellite systems, cellular hubs, Bluetooth, WiFi, and new technologies as they become available. The wildfire command system may be capable of outputting data to advanced interoperability systems such as ATAC, Perimeter, and Persistent Systems.

In some embodiments, the wildfire command system may integrate with or communicate with reverse 911 and similar systems to automatically notify people in the predicted path of the fire. The analysis module may include a training platform configured to train the AI submodule or AI algorithms thereof. The training sources may include, for example, one or more of resource capabilities databases such as manufacturer specifications of the capabilities and parameters for equipment, historical wildfire databases, weather databases, topographical databases, vegetation and fuel data database, satellite and aerial imagery databases, remote sensing databases, human observations, infrastructure, points of interest, and asset data databases, simulation and modeling data databases, air quality databases, social and economic data databases, research papers and studies databases, communication channels, or any combination thereof. Specifications of the capabilities and parameters of equipment may include, for example, an XYZ truck can travel 60 mph on zero slope, laden with full tank, 30 mph on a 25-degree slope, and cannot climb steeper than a 60 slope. It can carry 2000 gallons of water. It can operate on lateral surfaces of up to 20 degrees of slope. It can apply water over a distance of 200 feet from the truck. The fuel tank holds 150 gallons, which gives it an operational time of 16 hours between refills. This data is used to help the wildfire command system in its strategic chess game against a fire. Historical wildfire databases may include third-party source.

Such databases may include data such as drone data, aircraft sensor data, real-time fire behavior, or the like. Human observations may include sources such as reports from local fire departments or community platforms. Such databases may include data such as first-hand observations from firefighters, public reports, or the like. Such databases may include data such as location, number, or other specifics with respect to homes, businesses, schools, hospitals, industrial sites, military sites, roads, power lines, water sources, firefighter resources, or the like.

The AI submodule may be configured with various AI architectures for performing its operations and may include additional submodules, as needed. In one example, the AI submodule is configured with sensor fusion architecture wherein a distributed sensor ingestion framework handles, e.g., millions of, concurrent data streams from heterogeneous sensors for real time processing, e.g., via Apache Kafka queues and Flink. A geospatial-temporal indexing scheme may be configured to associate sensor data with location and time for hyperlocal real-time insights. A sensor fusion technique may integrate sensor data based on reliability weights and historical accuracy profiles of each sensor type.

In another or a further example, the AI submodule is configured with reinforcement learning for optimization configured to one or more of formulate the resource allocation problem as a Markov Decision Process optimized via asynchronous advantage actor-critic (A3C) algorithms; leverage multi-agent reinforcement learning with interconnected firefighting vehicles/assets as intelligent agents collaborating via deep RL; detail the state (fire data), action (asset deployment), reward (fire containment), and policy (asset control strategy) components.

In any of the above or another example, the AI submodule is configured to execute a quantum wildfire simulation that leverages quantum simulation algorithms on quantum hardware like D-Wave or Honeywell quantum systems to model wildfire propagation across a digital twin of the environment. Quantum simulation may be configured to provide representations of complex fire and weather dynamics that are intractable for classical computers. The quantum simulation may be configured to perform, e.g., millions of, concurrent simulations to evaluate high-risk scenarios and probability outcomes.

In any of the above or another example, the AI submodule is configured with quantum machine learning utilizing quantum versions of neural networks, like quantum convolutional neural nets, to analyze visual fire data and sensor streams with higher accuracy. Quantum machine learning may leverage qubit quantum states to massively parallelize data processing and pattern recognition. This may be used to output refined insights into fire hot spots, combustion properties, smoke dispersal patterns, or combination thereof.

In any of the above or another example, the AI submodule is configured to employ quantum optimization. Quantum optimization may apply quantum annealing and quantum approximate optimization techniques to optimize asset allocation, evaluate huge decision spaces of possible asset coordination strategies simultaneously, or combination thereof. Quantum optimization may be configured to provides superior real time logistics under rapidly evolving conditions.

In one example implementation of the wildfire command system, a lightning strike in Southern California ignites a wildfire. Sam, a wildfire Incident Commander, is assigned to manage the fire. Sam logs into a wildfire command system platform via a digital user interface provided on a computing device. The wildfire command system platform may present a list of locations, an input field, a satellite image, or the like for identification of fire location. In some embodiments, the wildfire command system may output a graphical display for presentation on a display of the user interface that populates with known fire locations. In this example, Sam pulls up a satellite image of the area and identifies the fire, and clicks on it. This triggers the wildfire command system to begin logging data from sensors in the area. The analysis module may make an initial assessment of the current size, severity, and projected movement of the fire, based on the wildfire command system's knowledge base of the topography of the area and current weather and fuel conditions. The OLIVAR module may prompt Sam to answer questions pertaining to available resources, such as number and type of fire trucks, crew, airplanes, etc. The wildfire command system may source some of this asset data by querying the Computer Aided Dispatch systems of nearby fire agencies to determine which of their assets are currently deployed, and which are available. As these Computer Aided Dispatch systems are updated, the wildfire command system may be informed as additional resources become available, and will add them to the resources available to be deployed on the current incident.

The wildfire command system may then access its database of valued assets in the threatened area, from a list of points of interest, which include a military base, a nuclear power plant, and a hospital. Sam is asked to rate the protection priorities, and ranks them 1) nuclear plant, 2) hospital, 3) military Base.

The analysis module may then run through millions of possible ways to deploy Sam's available assets, and in seconds, the output module delivers a continuously optimized suppression plan, suggesting to Sam where each vehicle should park, where to attack the fire first, where to deploy planes and helicopters, where to dig line with bulldozers, etc. Deeper details of the output cover all of the logistics of suppressing a fire, including, but not limited to items such as the sourcing and distribution schedule of water, fuel, and retardant for fire apparatus, crew meals, crew accommodations, heat load monitoring, crew safety plans and contingency plans.

With Sam's approval, the output module may then contact and issues response orders to each of Sam's assets. The output module may then automatically deploy any remote-control assets, such as drones, to survey areas where it needs more data. The output module may also automatically trigger Reverse 911 systems to notify residents and businesses in the area to prepare to evacuate, or to evacuate, and suggests evacuation routes that are passable. As more vehicles/aircraft/drones and their onboard sensor suites arrive and begin transmitting data back to the analysis module, the wildfire command system may update the continuously optimized suppression plan continuously, allowing Sam to update crew assignments immediately, and/or withdraw crews to safety.

The AI-based equipment allocation system may integrate inputs from a multiplicity of sensors, each selected and calibrated for its potential to provide valuable insights into wildfire behavior, and to alert users to additional hazards. The system can integrate data feeds from an unlimited number of individual or clustered sensors including any combination of, or all of, the following, and any future sensors that may be developed:
1. Location inputs, including Global positioning system (GPS);
2. Wind speed and direction;
3. Ambient temperature;
4. Humidity;
5. Barometric pressure;
6. Ultraviolet radiation exposure;
7. Ground slope angle and its orientation relative to the sun;
8. Vegetation moisture probes;
9. Vegetative density sensors;
10. Vegetation type identifiers;
11. Soil moisture probes;
12. High Resolution Video feeds, updated per current technology developments;
13. InfraRED (IR) cameras and sensors;
14. High resolution still imagery cameras;
15. Acoustic sensors;
16. Gas analyzers, including any combination of, but not limited to:
O2, O3, CO, CO2, NO, NO2, H2SO4, Chlorine compounds, Propane, Methane, Benzene, Acrolein, Polycyclic Aromatic Hydrocarbons (PAHs), Volatile Organic Compounds (VOCs), Hydrogen Cyanide (HCN), Sulfur Dioxide (SO₂), Ammonia (NH₃), Particulate Matter (PM2.5 and PM10) and other chemicals that may be present at, released or diminished by wildfire activity.
17. Ground vibration monitors;
18. Thermal radiometers;
19. LIDAR systems;
20. HADAR systems;
21. Air quality monitors;
22. Radiation detectors;
23. Microwave radiometry;
24. Radar systems;
25. Soil composition sensors;
26. Electromagnetic field (EMF) sensors;
27. Satellite imagery;
28. Data input from specialized fire movement and behavior programs;
29. External POI maps;
30. Topographic data;
31. Lightning detection devices;
32. Doppler/Other RADAR;
33. Decibel Meter.

The system may employ:
Computer Vision Techniques: Capabilities spanning object detection, segmentation, and real-time video analytics, crucial for early fire detection and trend prediction.
Dynamic Data Processing: Rapid processing and real-time analytics of vast amounts of data from diverse sources to ensure up-to-the-moment insights.
Continuous Learning Mechanisms: AI/ML models that adapt and refine their predictive accuracies and strategic recommendations based on incoming data streams and previously integrated models.
Delineated segments of the suppression plan are routed to quantum computing resources for analysis and processing, with their outputs then plugged back into the AI/ML module.

The system may solicit information about available local and national fire response Resources as additional inputs. When used in communities where Computer Aided Dispatch is used, the system can query these systems automatically, to determine what equipment, personnel and other resources are available. Some of the assets for which the disclosed system takes inventory follow and makes predictive allocation recommendations:

### Heavy Equipment Assets

Quantity and type of Bulldozers; are
Quantity and type of Graders;
Quantity and type of Backhoes

### Aerial Resources

Quantity and type of winged aircraft (Fixed wing, spotters, VLATs, etc.);
Quantity and type of rotary lift aircraft (Helicopters of various capabilities);

### Vehicular Assets

Quantity and type of Type 1 Trucks;
Quantity and type of Type 2 Trucks;
Quantity and type of Type 3 Trucks;
Quantity and type of Type 4 Trucks;
Quantity and type of Type 5 Trucks;
Quantity and type of Type 6 Trucks;
Quantity and type of Pickup Trucks;
Quantity and type of UTVs;
Quantity and type of Water Tenders.

### Marine Assets

Quantity and type of Type 1 Boats;
Quantity and type of Type 2 Boats;

### Personnel

Command Staff;
Supervisory Staff;
Firefighters;
Hand Crews;
Specialized Crew;
Drone Operators;
Communications Crew; and
Public Information Officers.

### Water Sources

Hydrants;
Ocean;
Rivers;
Streams;
Lakes;
Ponds;
Swimming Pools;
Storage Tanks;
Water Treatment Plants.

### Hand Tools

Chainsaws;
Rakes;
Hoes;
Axes;
Drip Torches;
Flappers.

### Team Wildfire Assets

Hurricane;
Cloud Burst;
Storm Cell;
Thunder Head.

### UAV/UAS Assets

Drones;
Unmanned helicopters.

### Consumables

Suppressants;
Retardants;
Foams;
Gels;
Accelerants.

### Support Services

Food;
Lodging;
Sanitation.

### Logistical Factors and limiting factors:

Distance between the fire and water sources;
Means and availability for transporting water to the fire;
Time to deliver water from source to destination;

Calculation of gallons per minute that can be delivered to the fire combining the above data.

As discussed above, some or all of the above listed available fire suppression assets may be pre-populated into an incident's data set by querying the dispatch software of nearby fire agencies (3d-partu sources) to determine which of that organization's assets are currently deployed elsewhere, and which assets are available.

The system may take into account manufacturer's specifications of the capabilities and parameters for every vehicle (i.e., an XYZ truck can travel 60 mph on zero slope, laden with full tank, 30 mph on a 25-degree slope, and cannot climb steeper than a 60 slope. It can carry 2000 gallons of water. It can operate on lateral surfaces of up to 20 degrees of slope. It can apply water over a distance of 200 feet from the truck. The fuel tank holds 150 gallons, which gives it an operational time of 16 hours between refills). This data may used to help to generate AI-based recommendations in the mathematical chess game against a fire.

The disclosed process according to one embodiment may, advantageously, eliminate the need for the fire commanders to analyze the massive fire-related data using transcripts produced by the NPL processing. Instead, the equipment allocation and fire suppression recommendations may be produced directly on a granular level based on fire-associated digital data according to the AI-based predictive analysis and fire suppression recommendations.

This process includes a transparent recommendations/equipment allocation mechanism that may be coupled with a secure communications chat channel (implemented over a blockchain network) which supports all parties to set and agree on the deployment procedures and terms of administering assets to the fire site with each other. In one embodiment, the chat channel may be implemented using a chat Bot.

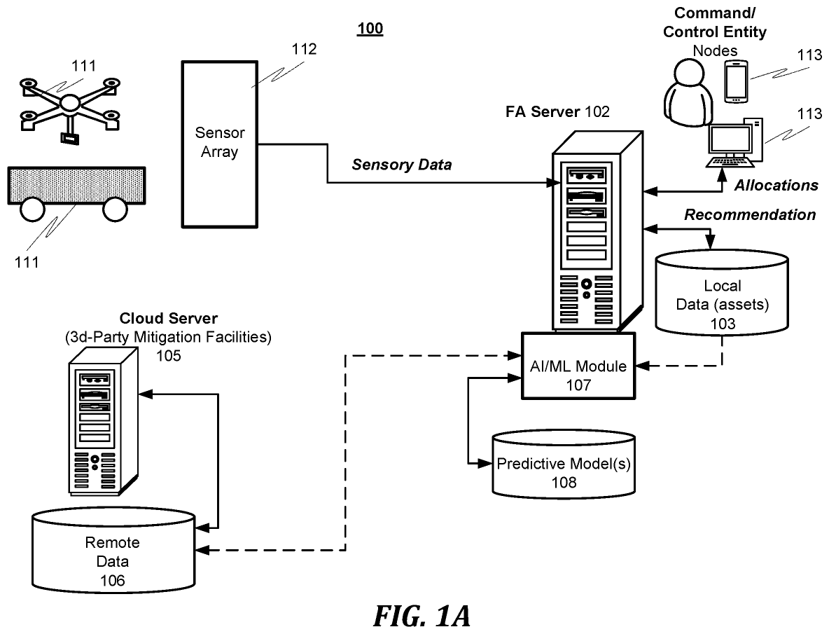

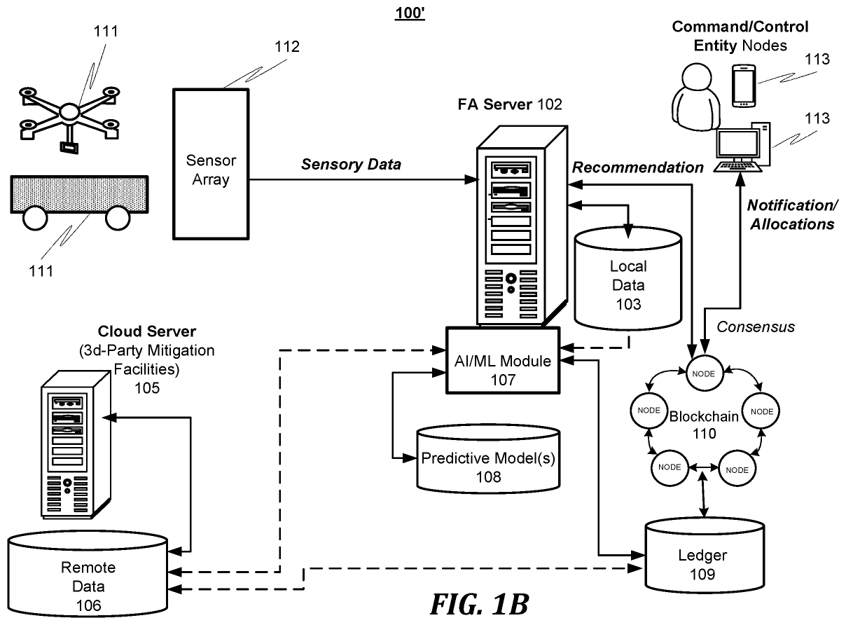

FIG. 1A illustrates a network diagram of a system for an AI-based automated real-time allocation of wildfire management and suppression equipment and assets based on predictive analytics of wildfire-related data consistent with the present disclosure.

Referring to FIG. 1A, the example network 100 includes the fire analysis server (FAS) node 102 connected to a cloud server node(s) 105 over a network. The FAS node 102 is configured to host an AI/ML module 107. The FAS node 102 may receive sensory data from an array of sensors 112 implemented on a fire surveillance device 111 (e.g., a drone or unmanned vehicle). The FAS node 102 may receive additional video/audio surveillance data from the fire surveillance device 111 implemented as a drone or an unmanned vehicle equipped with high resolution video capturing devices.

The audio surveillance data may have language indicator metadata representing the language of the surveying personnel (or chatbot) transcribing the surveillance data. In one embodiment, the audio surveillance data may be processed by the FAS node 102 using the pre-trained large language models. The FAS node 102 may derive the language indicator and parse out the audio surveillance data based on the language indicator metadata. In other words, the key features of the audio surveillance data may be derived from the audio surveillance data based on the language of the surveyor.

In one embodiment, the language indicator may serve as a kind of a linguistic profile associated with the audio surveillance data. The language indicator may guide the AI/ML module 107 in dynamically tailoring the processing methods. Depending on the language indicated, the FAS node 102 could engage specialized language models or apply unique natural language processing techniques optimized for that language.

Regarding the global reach of the disclosed system and method, a cultural intelligence layer may be added to the language indicator. The goal is for the system to not only recognize the language, but also adapt its recommendations and interactions to be culturally sensitive and appropriate. In one embodiment the disclosed system may employ integrated translation capabilities. This may allow both the surveyor associated with the surveillance device 111 and a chatbot to communicate effortlessly, no matter where they are in the world or what languages they use. The language indicator may be used to trigger/initiate this feature, making the system truly globally effective.

The FAS node 102 may query a local fire suppression and equipment database for the historical local wildfires' data 103 associated with the current wildfire. The FAS node 102 may acquire relevant remote historical wildfires' suppression-related data 106 from a remote database residing on a cloud server 105. The remote historical wildfires' suppression-related data 106 may be collected from other wildfire sites and suppression command and control facilities. The remote historical wildfires' suppression-related data 106 may be collected from the fire sites of the same (or similar) ambient condition(s), location, size, intensity, etc. as the local wildfires associated with the current wildfire-related data provided by the surveillance devices 111.

The FAS node 102 may generate a feature vector or classifier data based on the wildfire-related sensory data, available suppression assets (equipment and personnel) data and the collected wildfires'-related data (i.e., pre-stored local data 103 and remote data 106 reflecting characteristic of previous wildfires and the assets used for suppression). The FAS node 102 may ingest the feature vector data into an AI/ML module 107. The AI/ML module 107 may generate a predictive model(s) 108 based on the feature vector data to predict asset allocation parameters for automatically generating a deployment plan and fire suppression recommendations to be provided to the command-and-control entities 113 (e.g., unit commanders, equipment managers, etc.). The fire suppression plan and/or risk assessment parameters generated based on predictive outputs of the model(s) 108 may be further analyzed by the FAS node 102 prior to generation of the final mitigation/deployment plan. In one embodiment, the asset allocation parameters may be used for adjustment of the initial wildfire response based on current updated availability of the personnel and equipment. Once the asset allocation is determined, an allocations/notification may be sent to the command-and-control entities 113. Then the deployment plan may be approved by the command-and-control entities 113 based on the allocations and risk assessment.

FIG. 1B illustrates a network diagram of a system for an AI-based automated real-time allocation of wildfire management and suppression equipment based on predictive analytics of wildfire-related data implemented over a blockchain consistent with the present disclosure.

Referring to FIG. 1B, the example network 100′ includes the fire analysis server (FAS) node 102 connected to a cloud server node(s) 105 over a network. The FAS node 102 is configured to host an AI/ML module 107. The FAS node 102 may receive sensory data from an array of sensors 112 implemented on a fire surveillance device 111 (e.g., a drone or unmanned vehicle). The FAS node 102 may receive additional video/audio surveillance data from the fire surveillance device 111 implemented as a drone or an unmanned vehicle equipped with high resolution video capturing devices.

The audio surveillance data may have language indicator metadata representing the language of the surveying personnel (or chatbot) transcribing the surveillance data. In one embodiment, the audio surveillance data may be processed by the FAS node 102 using the pre-trained large language models. The FAS node 102 may derive the language indicator and parse out the audio surveillance data based on the language indicator metadata. In other words, the key features of the audio surveillance data may be derived from the audio surveillance data based on the language of the surveyor.

In one embodiment, the language indicator may serve as a kind of a linguistic profile associated with the audio surveillance data. The language indicator may guide the AI/ML module 107 in dynamically tailoring the processing methods. Depending on the language indicated, the FAS node 102 could engage specialized language models or apply unique natural language processing techniques optimized for that language.

In one embodiment the disclosed system may employ integrated translation capabilities. This may allow both the surveyor associated with the surveillance device 111 and a chatbot to communicate effortlessly, no matter where they are in the world or what languages they use. The language indicator may be used to trigger/initiate this feature, making the system truly globally effective.

The FAS node 102 may query a local fire suppression and equipment database for the historical local wildfires' data 103 associated with the current wildfire. The FAS node 102 may acquire relevant remote historical wildfires' suppression-related data 106 from a remote database residing on a cloud server 105. The remote historical wildfires' suppression-related data 106 may be collected from other wildfire sites and suppression command and control facilities. The remote historical wildfires' suppression-related data 106 may be collected from the fire sites of the same (or similar) ambient condition(s), location, size, intensity, etc. as the local wildfires associated with the current wildfire-related data provided by the surveillance devices 111.

The FAS node 102 may generate a feature vector or classifier data based on the wildfire-related sensory data, available suppression assets (equipment and personnel) data and the collected wildfires'-related data (i.e., pre-stored local data 103 and remote data 106). The FAS node 102 may ingest the feature vector data into an AI/ML module 107. The AI/ML module 107 may generate a predictive model(s) 108 based on the feature vector data to predict asset allocation parameters for automatically generating a deployment plan and fire suppression recommendations to be provided to the command-and-control entities 113 (e.g., unit commanders, equipment managers, etc.). The fire suppression plan and/or risk assessment parameters generated based on predictive outputs of the model(s) 108 may be further analyzed by the FAS node 102 prior to generation of the final mitigation/deployment plan. In one embodiment, the asset allocation parameters may be used for adjustment of the initial wildfire response based on current updated availability of the personnel and equipment. Once the asset allocation is determined, an allocations/notification may be sent to the command-and-control entities 113. Then the deployment plan may be approved by the command-and-control entities 113 based on the allocations and risk assessment.

In one embodiment, the FAS node 102 may receive the predicted asset allocation parameters from a permissioned blockchain 110 ledger 109 based on a consensus from the command-and-control entity nodes 113 confirming, for example, equipment and personnel allocations, wildfire suppression plan, deployment schedule and other conditions. Additionally, confidential historical wildfire suppression-related information and previous fires'-related asset allocation parameters may also be acquired from the permissioned blockchain 110. The newly acquired wildfire-related data with corresponding predicted asset allocation and deployment recommendation parameters data may be also recorded on the ledger 109 of the blockchain 110 so it can be used as training data for the predictive model(s) 108. In this implementation the FAS node 102, the command-and-control entity nodes 113 and surveyors' entities (not shown) may serve as blockchain 110 peer nodes. In one embodiment, local wildfires' data 103 and remote data 106 may be duplicated on the blockchain ledger 109 for higher security of storage. Allocation of assets may be recorded on the blockchain 110 as transaction indicating asset ownership and/or assignment.

The AI/ML module 107 may generate a predictive model(s) 108 to predict the asset allocation and deployment recommendation parameters for the current wildfire site in response to the specific relevant pre-stored fires'-related data (including asset allocations data) acquired from the blockchain 110 ledger 109. This way, the current asset allocations and deployment parameters may be predicted based not only on the current wildfire-related sensory data and current asset availability data, but also based on the previously collected heuristics and wildfires'-related data associated with the given wildfire site data or current allocation parameters generated based on the sensory data and surveillance data. This way, the most optimal way of handling the wildfire such as the best personnel and equipment are selected for suppressing the wildfire, for the most likely successful mitigation.

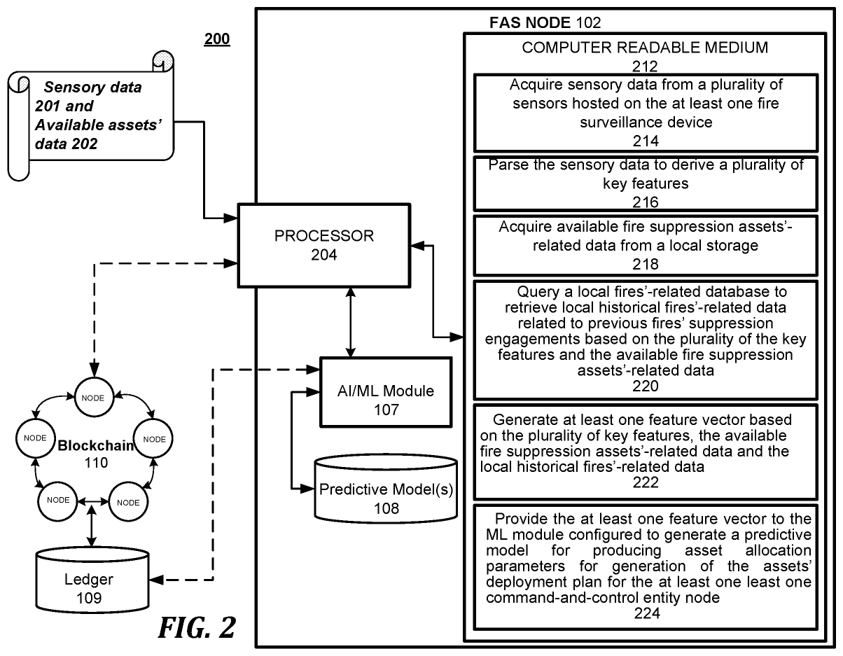

FIG. 2 illustrates a network diagram of a system including detailed features of a fire analysis server (FAS) node consistent with the present disclosure.

Referring to FIG. 2, the example network 200 includes the FAS node 102 connected to the sensor array 112 implemented on the surveillance devices 111 (see FIGS. 1A-1B) to receive the sensory data 201. The FAS node 102 is also connected to a local storage containing available assets' data 202.

The FAS node 102 is configured to host an AI/ML module 107. As discussed above with respect to FIGS. 1A-B, the FAS node 102 may receive the sensory data provided by the surveillance devices 111 (FIG. 1A) and pre-stored wildfires'-related data retrieved from local and remote databases. As discussed above, the wildfires'-related data may be optionally retrieved from the ledger 109 of the blockchain 110.

The AI/ML module 107 may generate a predictive model(s) 108 based on the received wildfire-related sensory data 201 and 202 and the surveillance'-related video/audio data provided by the FAS node 102. As discussed above, the AI/ML module 107 may provide predictive outputs data in the form of asset allocation parameters for automatic generation of deployment and suppression recommendations for the command-and-control entities 113 (see FIG. 1B). The FAS node 102 may process the predictive outputs data received from the AI/ML module 107 to generate the asset deployment plan and/or risk assessment recommendation pertaining to a particular wildfire suppression/mitigation engagement.

In one embodiment, the FAS node 102 may acquire and process current sensory data 201. In another embodiment, the FAS node 102 may continually monitor sensory data and may detect a parameter that deviates from a previous recorded parameter (or from a median reading value) by a margin that exceeds a threshold value pre-set for this particular parameter. For example, if a fire's intensity, spread and movement rate change, this may cause a change in asset allocations or risk assessment. Accordingly, once the threshold is met or exceeded by at least one parameter of the wildfire, the FAS node 102 may provide the currently acquired fire-related sensory parameter to the AI/ML module 107 to generate an updated asset allocation or deployment recommendation parameters based on the current wildfire's conditions and updated risk assessment parameters.

While this example describes in detail only one FAS node 102, multiple such nodes may be connected to the network and to the blockchain 110. It should be understood that the FAS node 102 may include additional components and that some of the components described herein may be removed and/or modified without departing from a scope of the FAS node 102 disclosed herein. The FAS node 102 may be a computing device or a server computer, or the like, and may include a processor 204, which may be a semiconductor-based microprocessor, a central processing unit (CPU), an application specific integrated circuit (ASIC), a field-programmable gate array (FPGA), and/or another hardware device. Although a single processor 204 is depicted, it should be understood that the FAS node 102 may include multiple processors, multiple cores, or the like, without departing from the scope of the FAS node 102 system.

The FAS node 102 may also include a non-transitory computer readable medium 212 that may have stored thereon machine-readable instructions executable by the processor 204. Examples of the machine-readable instructions are shown as 214-224 and are further discussed below. Examples of the non-transitory computer readable medium 212 may include an electronic, magnetic, optical, or other physical storage device that contains or stores executable instructions. For example, the non-transitory computer readable medium 212 may be a Random-Access memory (RAM), an Electrically Erasable Programmable Read-Only Memory (EEPROM), a hard disk, an optical disc, or other type of storage device.

The processor 204 may fetch, decode, and execute the machine-readable instructions 214 to acquire sensory data from a plurality of sensors hosted on the at least one fire surveillance device. The processor 204 may fetch, decode, and execute the machine-readable instructions 216 to parse the sensory data to derive a plurality of key features. The processor 204 may fetch, decode, and execute the machine-readable instructions 218 to acquire available fire suppression assets'-related data from a local storage. The processor 204 may fetch, decode, and execute the machine-readable instructions 220 to query a local fires'-related database to retrieve local historical fires'-related data related to previous fires' suppression engagements based on the plurality of the key features and available fire suppression assets'-related data.

The processor 204 may fetch, decode, and execute the machine-readable instructions 222 to generate at least one feature vector based on the plurality of key features, the available fire suppression assets'-related data and the local historical fires'-related data. The processor 204 may fetch, decode, and execute the machine-readable instructions 224 to provide the at least one feature vector to the ML module configured to generate a predictive model for producing asset allocation parameters for generation of the assets' deployment plan for the at least one least one command-and-control entity node.

The permissioned blockchain 110 may be configured to use one or more smart contracts that manage transactions for multiple participating nodes and for recording the transactions on the ledger 109.

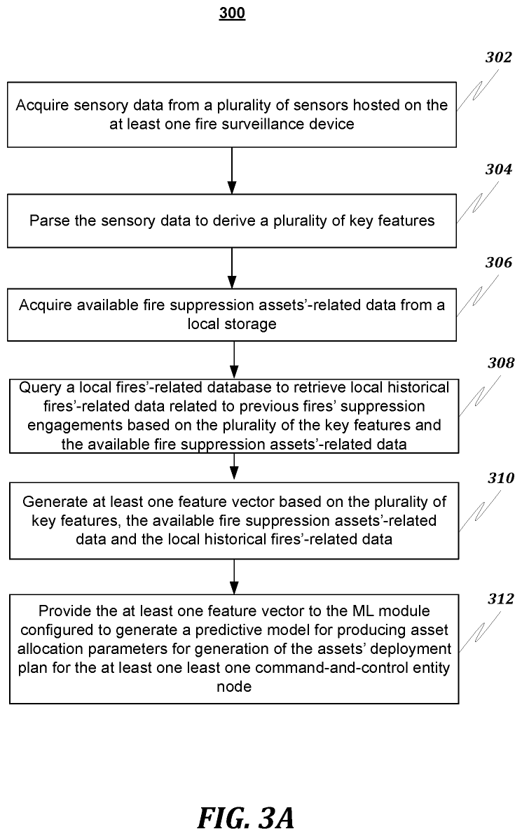

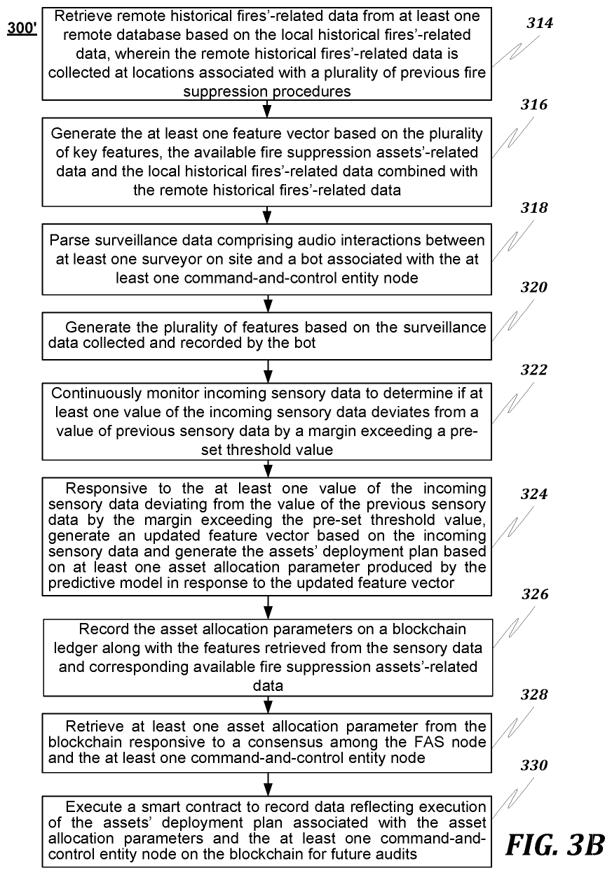

FIG. 3A illustrates a flowchart of a method for an AI-based automated real-time allocation of wildfire management and suppression equipment based on predictive analytics of wildfire-related data consistent with the present disclosure.

Referring to FIG. 3A, the method 300 may include one or more of the steps described below. FIG. 3A illustrates a flow chart of an example method executed by the FAS node 102 (see FIG. 2). It should be understood that method 300 depicted in FIG. 3A may include additional operations and that some of the operations described therein may be removed and/or modified without departing from the scope of the method 300. The description of the method 300 is also made with reference to the features depicted in FIG. 2 for purposes of illustration. Particularly, the processor 204 of the FAS node 102 may execute some or all of the operations included in the method 300.

With reference to FIG. 3A, at block 302, the processor 204 may acquire sensory data from a plurality of sensors hosted on the at least one fire surveillance device. At block 304, the processor 204 may parse the sensory data to derive a plurality of key features. At block 306, the processor 204 may acquire available fire suppression assets'-related data from a local storage. At block 308, the processor 204 may query a local fires'-related database to retrieve local historical fires'-related data related to previous fires' suppression engagements based on the plurality of the key features and available fire suppression assets'-related data. At block 310, the processor 204 may generate at least one feature vector based on the plurality of key features, the available fire suppression assets'-related data and the local historical fires'-related data. At block 312, the processor 204 may provide the at least one feature vector to the ML module configured to generate a predictive model for producing asset allocation parameters for generation of the assets' deployment plan for the at least one least one command-and-control entity node.

FIG. 3B illustrates a further flowchart of a method for AI-based automated real-time allocation of wildfire management and suppression equipment based on predictive analytics of wildfire-related data consistent with the present disclosure.

Referring to FIG. 3B, the method 300′ may include one or more of the steps described below.

FIG. 3B illustrates a flow chart of an example method executed by the FAS node 102 (see FIG. 2). It should be understood that method 300′ depicted in FIG. 3B may include additional operations and that some of the operations described therein may be removed and/or modified without departing from the scope of the method 300′. The description of the method 300′ is also made with reference to the features depicted in FIG. 2 for purposes of illustration. Particularly, the processor 204 of the FAS node 102 may execute some or all of the operations included in the method 300′.

With reference to FIG. 3B, at block 314, the processor 204 may retrieve remote historical fires'-related data from at least one remote database based on the local historical fires'-related data, wherein the remote historical fires'-related data is collected at locations associated with a plurality of previous fire suppression procedures. At block 316, the processor 204 may generate the at least one feature vector based on the plurality of key features, the available fire suppression assets'-related data and the local historical fires'-related data combined with the remote historical fires'-related data. At block 318, the processor 204 may parse surveillance data comprising audio interactions between at least one surveyor on site and a bot associated with the at least one command-and-control entity node. At block 320, the processor 204 may generate the plurality of features based on the surveillance data collected and recorded by the bot.

At block 322, the processor 204 may continuously monitor incoming sensory data to determine if at least one value of the incoming sensory data deviates from a value of previous sensory data by a margin exceeding a pre-set threshold value. At block 324, the processor 204 may, responsive to the at least one value of the incoming sensory data deviating from the value of the previous sensory data by the margin exceeding the pre-set threshold value, generate an updated feature vector based on the incoming sensory data and generate the assets' deployment plan based on at least one asset allocation parameter produced by the predictive model in response to the updated feature vector. At block 326, the processor 204 may record the asset allocation parameters on a blockchain ledger along with the features retrieved from the sensory data and corresponding available fire suppression assets'-related data. At block 328, the processor 204 may retrieve at least one asset allocation parameter from the blockchain responsive to a consensus among the FAS node and the at least one command-and-control entity node. At block 330, the processor 204 may execute a smart contract to record data reflecting execution of the assets' deployment plan associated with the asset allocation parameters and the at least one command-and-control entity node on the blockchain for future audits.

In one disclosed embodiment, the assets' allocation parameters' model may be generated by the AI/ML module 107 that may use training data sets to improve accuracy of the prediction of the assets' allocation parameters for the command-and-control entities 113 (FIGS. 1A-1B). The assets' allocation parameters used in training data sets may be stored in a centralized local database (such as one used for storing local fires' data 103 depicted in FIG. 1A). In one embodiment, a neural network may be used in the AI/ML module 107 for assets' allocation parameters modeling and deployment predictions.

In another embodiment, the AI/ML module 107 may use a decentralized storage such as a blockchain 110 (see FIG. 1B) that is a distributed storage system, which includes multiple nodes that communicate with each other. The decentralized storage includes an append-only immutable data structure resembling a distributed ledger capable of maintaining records between mutually untrusted parties. The untrusted parties are referred to herein as peers or peer nodes. Each peer maintains a copy of the parameter(s) records and no single peer can modify the records without a consensus being reached among the distributed peers. For example, the peers 113 and 102 (FIG. 1B) may execute a consensus protocol to validate blockchain 110 storage transactions, group the storage transactions into blocks, and build a hash chain over the blocks. This process forms the ledger 109 by ordering the storage transactions, as is necessary, for consistency. In various embodiments, a permissioned and/or a permissionless blockchain can be used. In a public or permissionless blockchain, anyone can participate without a specific identity. Public blockchains can involve assets and use consensus based on various protocols such as Proof of Work (PoW). On the other hand, a permissioned blockchain provides secure interactions among a group of entities which share a common goal such as asset allocation parameters for efficient suppression of wildfires, but which do not fully trust one another.

This application utilizes a permissioned (private) blockchain that operates arbitrary, programmable logic, tailored to a decentralized storage scheme and referred to as “smart contracts” or “chaincodes.” In some cases, specialized chaincodes may exist for management functions and parameters which are referred to as system chaincodes. The application can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded. An endorsement policy allows chaincodes to specify endorsers for a transaction in the form of a set of peer nodes that are necessary for endorsement. When a client sends the transaction to the peers specified in the endorsement policy, the transaction is executed to validate the transaction. After a validation, the transactions enter an ordering phase in which a consensus protocol is used to produce an ordered sequence of endorsed transactions grouped into blocks.

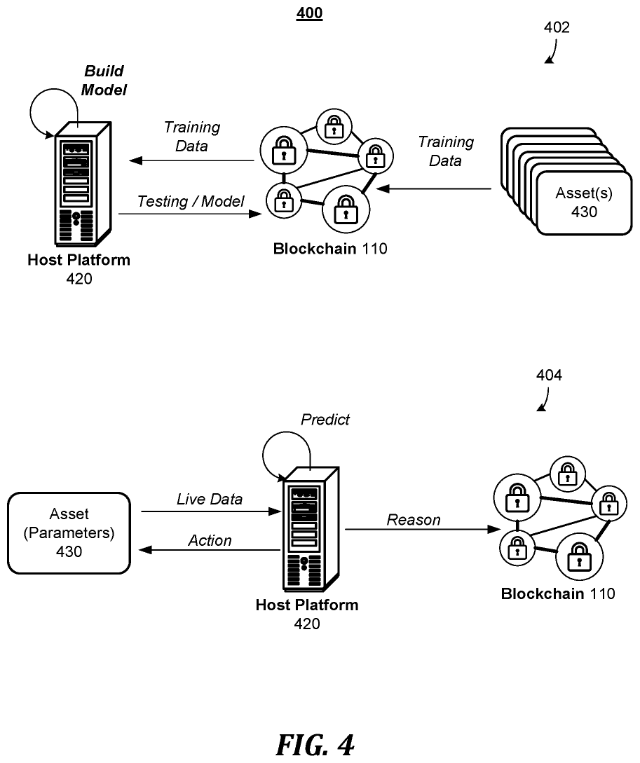

In the example depicted in FIG. 4, a host platform 420 (such as the FAS node 102) builds and deploys a machine learning model for predictive monitoring of assets 430. Here, the host platform 420 may be a cloud platform, an industrial server, a web server, a personal computer, a user device, and the like. Assets 430 can represent equipment and personnel allocation parameters as well as the actual fire suppression assets. The blockchain 110 can be used to significantly improve both a training process 402 of the machine learning model and the assets' allocation parameters' predictive process 404 based on a trained machine learning model. For example, in 402, rather than requiring a data scientist/engineer or other user to collect the data, historical data (heuristics-i.e., wildfires'-related data) may be stored by the assets 430 themselves (or through an intermediary, not shown) on the blockchain 110.

This can significantly reduce the collection time needed by the host platform 420 when performing predictive model training. For example, using smart contracts, data can be directly and reliably transferred straight from its place of origin (e.g., from the FAS node 102 or from the databases 103 and 106 depicted in FIGS. 1A-1B) to the blockchain 110. By using the blockchain 110 to ensure the security and ownership of the collected data, smart contracts may directly send the data from the assets to the entities that use the data for building a machine learning model. This allows for sharing of data among the assets 430. The collected data may be stored in the blockchain 110 based on a consensus mechanism. The consensus mechanism pulls in (permissioned nodes) to ensure that the data being recorded is verified and accurate. The data recorded is time-stamped, cryptographically signed, and immutable. It is therefore auditable, transparent, and secure.

Furthermore, training of the machine learning model on the collected data may take rounds of refinement and testing by the host platform 420. Each round may be based on additional data or data that was not previously considered to help expand the knowledge of the machine learning model. In 402, the different training and testing steps (and the data associated therewith) may be stored on the blockchain 110 by the host platform 420. Each refinement of the machine learning model (e.g., changes in variables, weights, etc.) may be stored on the blockchain 110. This provides verifiable proof of how the model was trained and what data was used to train the model. Furthermore, when the host platform 420 has achieved a finally trained model, the resulting model itself may be stored on the blockchain 110.

After the model has been trained, it may be deployed to a live environment where it can make recommendation-related predictions/decisions based on the execution of the final trained machine learning model using the prediction parameters. In this example, data fed back from the asset 430 may be input into the machine learning model and may be used to make event predictions such as most optimal asset allocation and deployment parameters for setting the wildfire suppression plans. Determinations made by the execution of the machine learning model (e.g., assets' allocation and deployment recommendations, risk assessment data, etc.) at the host platform 420 may be stored on the blockchain 110 to provide auditable/verifiable proof. As one non-limiting example, the machine learning model may predict a future change of a part of the asset 430 (the assets' allocation recommendation parameters—i.e., assessment of risk of unsuccessful fire suppression efforts). The data behind this decision may be stored by the host platform 420 on the blockchain 110.

As discussed above, in one embodiment, the features and/or the actions described and/or depicted herein can occur on or with respect to the blockchain 110. The above embodiments of the present disclosure may be implemented in hardware, in computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

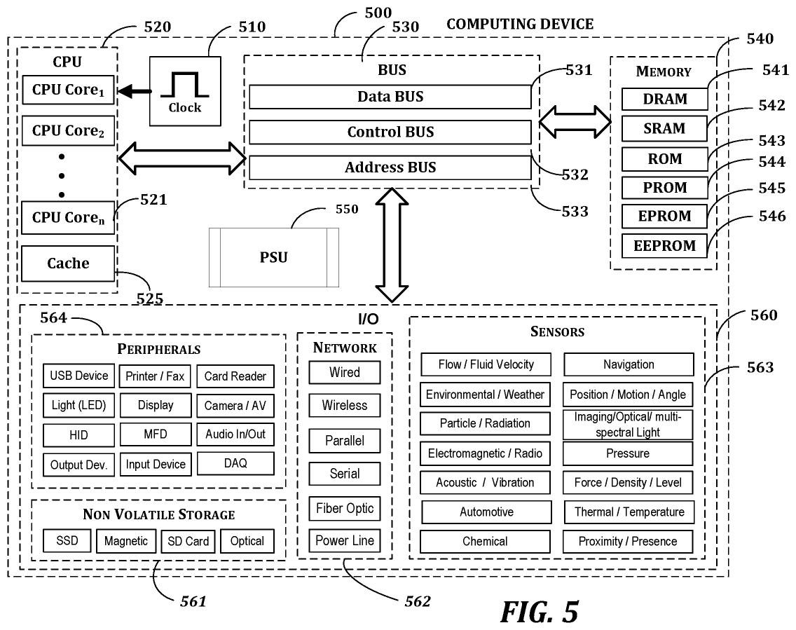

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative embodiment, the processor and the storage medium may reside as discrete components. For example, FIG. 5 illustrates an example computing device (e.g., a server node) 500, which may represent or be integrated in any of the above-described components, etc.

FIG. 5 illustrates a block diagram of a system including computing device 500. The computing device 500 may comprise, but not be limited to the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS500/iSeries/System I, A DEC VAX/PDP, a HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack mounted, a workstation, an industrial device, a raspberry pi, a desktop, or an embedded device;

The FAS node 102 (see FIG. 2) may be hosted on a centralized server or on a cloud computing service. Although method 300 has been described to be performed by the FAS node 102 implemented on a computing device 500, it should be understood that, in some embodiments, different operations may be performed by a plurality of the computing devices 500 in operative communication at least one network.

Embodiments of the present disclosure may comprise a computing device having a central processing unit (CPU) 520, a bus 530, a memory unit 540, a power supply unit (PSU) 540, and one or more Input/Output (I/O) units. The CPU 520 coupled to the memory unit 540 and the plurality of I/O units 560 via the bus 530, all of which are powered by the PSU 540. It should be understood that, in some embodiments, each disclosed unit may actually be a plurality of such units for the purposes of redundancy, high availability, and/or performance. The combination of the presently disclosed units is configured to perform the stages of any method disclosed herein.

Consistent with an embodiment of the disclosure, the aforementioned CPU 520, the bus 530, the memory unit 540, a PSU 540, and the plurality of I/O units 560 may be implemented in a computing device, such as computing device 500. Any suitable combination of hardware, software, or firmware may be used to implement the aforementioned units. For example, the CPU 520, the bus 530, and the memory unit 540 may be implemented with computing device 500 or any of other computing devices 500, in combination with computing device 500. The aforementioned system, device, and components are examples and other systems, devices, and components may comprise the aforementioned CPU 520, the bus 530, the memory unit 540, consistent with embodiments of the disclosure.

At least one computing device 500 may be embodied as any of the computing elements illustrated in all of the attached figures, including the FAS node 102 (FIG. 2). A computing device 500 does not need to be electronic, nor even have a CPU 520, nor bus 530, nor memory unit 540. The definition of the computing device 500 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 500, especially if the processing is purposeful.

With reference to FIG. 5, a system consistent with an embodiment of the disclosure may include a computing device, such as computing device 500. In a basic configuration, computing device 500 may include at least one clock module 510, at least one CPU 520, at least one bus 530, and at least one memory unit 540, at least one PSU 540, and at least one I/O 560 module, wherein I/O module may be comprised of, but not limited to a non-volatile storage sub-module 561, a communication sub-module 562, a sensors sub-module 563, and a peripherals sub-module 565.

A system consistent with an embodiment of the disclosure the computing device 500 may include the clock module 510 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 520, the central component of modern computers, which relies on a clock. The only exceptions are asynchronous circuits such as asynchronous CPUs. The clock 510 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 5 wires.

Many computing devices 500 use a “clock multiplier” which multiplies a lower frequency external clock to the appropriate clock rate of the CPU 520. This allows the CPU 520 to operate at a much higher frequency than the rest of the computer, which affords performance gains in situations where the CPU 520 does not need to wait on an external factor (like memory 540 or input/output 560). Some embodiments of the clock 510 may include dynamic frequency change, where the time between clock edges can vary widely from one edge to the next and back again.

A system consistent with an embodiment of the disclosure the computing device 500 may include the CPU unit 520 comprising at least one CPU Core 521. A plurality of CPU cores 521 may comprise identical CPU cores 521, such as, but not limited to, homogeneous multi-core systems. It is also possible for the plurality of CPU cores 521 to comprise different CPU cores 521, such as, but not limited to, heterogeneous multi-core systems, big.LITTLE systems and some AMD accelerated processing units (APU). The CPU unit 520 reads and executes program instructions which may be used across many application domains, for example, but not limited to, general purpose computing, embedded computing, network computing, digital signal processing (DSP), and graphics processing (GPU). The CPU unit 520 may run multiple instructions on separate CPU cores 521 at the same time. The CPU unit 520 may be integrated into at least one of a single integrated circuit die and multiple dies in a single chip package. The single integrated circuit die and multiple dies in a single chip package may contain a plurality of other aspects of the computing device 500, for example, but not limited to, the clock 510, the CPU 520, the bus 530, the memory 540, and I/O 560.

The CPU unit 520 may contain cache 522 such as, but not limited to, a level 1 cache, level 2 cache, level 3 cache or combination thereof. The aforementioned cache 522 may or may not be shared amongst a plurality of CPU cores 521. The cache 522 sharing comprises at least one of message passing and inter-core communication methods may be used for the at least one CPU Core 521 to communicate with the cache 522. The inter-core communication methods may comprise, but not limited to, bus, ring, two-dimensional mesh, and crossbar. The aforementioned CPU unit 520 may employ symmetric multiprocessing (SMP) design.

The plurality of the aforementioned CPU cores 521 may comprise soft microprocessor cores on a single field programmable gate array (FPGA), such as semiconductor intellectual property cores (IP Core). The plurality of CPU cores 521 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 521, for example, but not limited to Instruction-level parallelism (ILP) such as, but not limited to, superscalar pipelining, and Thread-level parallelism (TLP).

Consistent with the embodiments of the present disclosure, the aforementioned computing device 500 may employ a communication system that transfers data between components inside the aforementioned computing device 500, and/or the plurality of computing devices 500. The aforementioned communication system will be known to a person having ordinary skill in the art as a bus 530. The bus 530 may embody internal and/or external plurality of hardware and software components, for example, but not limited to a wire, optical fiber, communication protocols, and any physical arrangement that provides the same logical function as a parallel electrical bus. The bus 530 may comprise at least one of, but not limited to a parallel bus, wherein the parallel bus carry data words in parallel on multiple wires, and a serial bus, wherein the serial bus carry data in bit-serial form. The bus 530 may embody a plurality of topologies, for example, but not limited to, a multidrop/electrical parallel topology, a daisy chain topology, and a connected by switched hubs, such as USB bus. The bus 530 may comprise a plurality of embodiments, for example, but not limited to:
Internal data bus (data bus) 531/Memory bus
Control bus 532
Address bus 533
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCle v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/105 bus (e.g., PC/105-Plus, PCI/105-Express, PCI/105, and PCI-105), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1395 Interface/Firewire, Thunderbolt, and extensible Host Controller Interface (xHCI).

Consistent with the embodiments of the present disclosure, the aforementioned computing device 500 may employ hardware integrated circuits that store information for immediate use in the computing device 500, known to the person having ordinary skill in the art as primary storage or memory 540. The memory 540 operates at high speed, distinguishing it from the non-volatile storage sub-module 561, which may be referred to as secondary or tertiary storage, which provides slow-to-access information but offers higher capacities at lower cost. The contents contained in memory 540, may be transferred to secondary storage via techniques such as, but not limited to, virtual memory and swap. The memory 540 may be associated with addressable semiconductor memory, such as integrated circuits consisting of silicon-based transistors, used for example as primary storage but also other purposes in the computing device 500. The memory 540 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 541, Static Random-Access Memory (SRAM) 542, CPU Cache memory 525, Advanced Random-Access Memory (A-RAM), and other types of primary storage such as Random-Access Memory (RAM).
Non-volatile memory which can retain stored information even after power is removed, for example, but not limited to, Read-Only Memory (ROM) 543, Programmable ROM (PROM) 545, Erasable PROM (EPROM) 545, Electrically Erasable PROM (EEPROM) 546 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).
Consistent with the embodiments of the present disclosure, the aforementioned computing device 500 may employ the communication system between an information processing system, such as the computing device 500, and the outside world, for example, but not limited to, human, environment, and another computing device 500. The aforementioned communication system will be known to a person having ordinary skill in the art as I/O 560. The I/O module 560 regulates a plurality of inputs and outputs with regard to the computing device 500, wherein the inputs are a plurality of signals and data received by the computing device 500, and the outputs are the plurality of signals and data sent from the computing device 500. The I/O module 560 interfaces a plurality of hardware, such as, but not limited to, non-volatile storage 561, communication devices 562, sensors 563, and peripherals 565. The plurality of hardware is used by at least one of, but not limited to, human, environment, and another computing device 500 to communicate with the present computing device 500. The I/O module 560 may comprise a plurality of forms, for example, but not limited to channel I/O, port mapped I/O, asynchronous I/O, and Direct Memory Access (DMA).
Consistent with the embodiments of the present disclosure, the aforementioned computing device 500 may employ the non-volatile storage sub-module 561, which may be referred to by a person having ordinary skill in the art as one of secondary storage, external memory, tertiary storage, off-line storage, and auxiliary storage. The non-volatile storage sub-module 561 may not be accessed directly by the CPU 520 without using an intermediate area in the memory 540. The non-volatile storage sub-module 561 does not lose data when power is removed and may be two orders of magnitude less costly than storage used in memory modules, at the expense of speed and latency. The non-volatile storage sub-module 561 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (561) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 500 may employ the communication sub-module 562 as a subset of the I/O 560, which may be referred to by a person having ordinary skill in the art as at least one of, but not limited to, computer network, data network, and network. The network allows computing devices 500 to exchange data using connections, which may be known to a person having ordinary skill in the art as data links, between network nodes. The nodes comprise network computer devices 500 that originate, route, and terminate data. The nodes are identified by network addresses and can include a plurality of hosts consistent with the embodiments of a computing device 500. The aforementioned embodiments include, but not limited to personal computers, phones, servers, drones, and networking devices such as, but not limited to, hubs, switches, routers, modems, and firewalls.

Two nodes can be networked together, when one computing device 500 is able to exchange information with the other computing device 500, whether or not they have a direct connection with each other. The communication sub-module 562 supports a plurality of applications and services, such as, but not limited to World Wide Web (WWW), digital video and audio, shared use of application and storage computing devices 500, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 5 [IPv5], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 562 may comprise a plurality of size, topology, traffic control mechanism and organizational intent. The communication sub-module 562 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Cellular systems embody technologies such as, but not limited to, 3G,5G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line and wireless communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 500 may employ the sensors sub-module 563 as a subset of the I/O 560. The sensors sub-module 563 comprises at least one of the devices, modules, and subsystems whose purpose is to detect events or changes in its environment and send the information to the computing device 500. Sensors are sensitive to the measured property, are not sensitive to any property not measured, but may be encountered in its application, and do not significantly influence the measured property. The sensors sub-module 563 may comprise a plurality of digital devices and analog devices, wherein if an analog device is used, an Analog to Digital (A-to-D) converter must be employed to interface the said device with the computing device 500. The sensors may be subject to a plurality of deviations that limit sensor accuracy. The sensors sub-module 563 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:

Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nano-sensors).

Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, LiDAR, multi-spectral light sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezo capacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 500 may employ the peripherals sub-module 562 as a subset of the I/O 560. The peripheral sub-module 565 comprises ancillary devices used to put information into and get information out of the computing device 500. There are 3 categories of devices comprising the peripheral sub-module 565, which exist based on their relationship with the computing device 500, input devices, output devices, and input/output devices. Input devices send at least one of data and instructions to the computing device 500. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 500. Output devices convert electronically generated information into a form that can be presented to humans. Input/output devices that perform both input and output functions. It should be understood by a person having ordinary skill in the art that the ensuing are non-limiting embodiments of the aforementioned peripheral sub-module 565:

### Input Devices

Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
High degree of freedom devices, that require up to six degrees of freedom such as, but not limited to, camera gimbals, Cave Automatic Virtual Environment (CAVE), and virtual reality systems.
Video Input devices are used to digitize images or video from the outside world into the computing device 500. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
Audio input devices are used to capture sound. In some cases, an audio output device can be used as an input device, in order to capture produced sound. Audio input devices allow a user to send audio signals to the computing device 500 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrument Digital Interface (MIDI) devices such as, but not limited to a keyboard, and headset.
Data Acquisition (DAQ) devices convert at least one of analog signals and physical parameters to digital values for processing by the computing device 500. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:
Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.
Audio and Video (AV) devices, such as, but not limited to, speakers, headphones, amplifiers and lights, which include lamps, strobes, DJ lighting, stage lighting, architectural lighting, special effect lighting, and lasers.
Other devices such as Digital to Analog Converter (DAC)

Input/Output Devices may further comprise, but not be limited to, touchscreens, networking device (e.g., devices disclosed in network 562 sub-module), data storage device (non-volatile storage 561), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

1. A system for generation of wildfire suppression asset allocation based on wildfire-related data, comprising:
a processor of a fire analysis server (FAS) node configured to host a machine learning (ML) module and connected to at least one fire surveillance device and to at least one command-and-control entity node over a wireless network; and
a memory on which are stored machine-readable instructions that when executed by the processor, cause the processor to:
acquire sensory data from a plurality of sensors hosted on the at least one fire surveillance device;
parse the sensory data to derive a plurality of key features;
acquire available fire suppression assets'-related data from a local storage;
query a local fires'-related database to retrieve local historical fires'-related data related to previous fires' suppression engagements based on the plurality of the key features and the available fire suppression assets'-related data;
generate at least one feature vector based on the plurality of key features, the available fire suppression assets'-related data and the local historical fires'-related data; and
provide the at least one feature vector to the ML module configured to generate a predictive model for producing asset allocation parameters for generation of the assets' deployment plan for the at least one least one command-and-control entity node.

2. The system of claim 1, wherein the instructions further cause the processor to retrieve remote historical fires'-related data from at least one remote database based on the local historical fires'-related data, wherein the remote historical fires'-related data is collected at locations associated with a plurality of previous fire suppression procedures.

3. The system of claim 2, wherein the instructions further cause the processor to generate the at least one feature vector based on the plurality of key features, the available fire suppression assets'-related data and the local historical fires'-related data combined with the remote historical fires'-related data.

4. The system of claim 1, wherein the instructions further cause the processor to parse surveillance data comprising audio interactions between at least one surveyor on site and a bot associated with the at least one command-and-control entity node.

5. The system of claim 4, wherein the instructions further cause the processor to generate the plurality of features based on the surveillance data collected and recorded by the bot.

6. The system of claim 1, wherein the instructions further cause the processor to continuously monitor incoming sensory data to determine if at least one value of the incoming sensory data deviates from a value of previous sensory data by a margin exceeding a pre-set threshold value.

7. The system of claim 6, wherein the instructions further cause the processor to, responsive to the at least one value of the incoming sensory data deviating from the value of the previous sensory data by the margin exceeding the pre-set threshold value, generate an updated feature vector based on the incoming sensory data and generate the assets' deployment plan based on at least one asset allocation parameter produced by the predictive model in response to the updated feature vector.

8. The system of claim 1, wherein the instructions further cause the processor to record the asset allocation parameters on a blockchain ledger along with the features retrieved from the sensory data and corresponding available fire suppression assets'-related data.

9. The system of claim 8, wherein the instructions further cause the processor to retrieve at least one asset allocation parameter from the blockchain responsive to a consensus among the FAS node and the at least one command-and-control entity node.

10. The system of claim 8, wherein the instructions further cause the processor to execute a smart contract to record data reflecting execution of the assets' deployment plan associated with the asset allocation parameters and the at least one command-and-control entity node on the blockchain for future audits.

11. A method for generation of wildfire suppression asset allocation based on wildfire-related data, comprising:
acquiring, by a fire analysis server (FAS) configured to host a machine-learning module (ML), sensory data from a plurality of sensors hosted on the at least one fire surveillance device;
parsing, by the FAS, the sensory data to derive a plurality of key features;
acquiring, by the FAS, available fire suppression assets'-related data from a local storage;
querying, by the FAS, a local fires'-related database to retrieve local historical fires'-related data related to previous fires' suppression engagements based on the plurality of the key features and the available fire suppression assets'-related data;
generating, by the FAS, at least one feature vector based on the plurality of key features, the available fire suppression assets'-related data and the local historical fires'-related data; and
providing, by the FAS, the at least one feature vector to the ML module configured to generate a predictive model for producing asset allocation parameters for generation of the assets' deployment plan for the at least one least one command-and-control entity node.

12. The method of claim 11, further comprising retrieving remote historical fires'-related data from at least one remote database based on the local historical fires'-related data, wherein the remote historical fires'-related data is collected at locations associated with a plurality of previous fire suppression procedures.

13. The method of claim 12, further comprising generating the at least one feature vector based on the plurality of key features, the available fire suppression assets'-related data and the local historical fires'-related data combined with the remote historical fires'-related data.

14. The method of claim 11, further comprising continuously monitoring incoming sensory data to determine if at least one value of the incoming sensory data deviates from a value of previous sensory data by a margin exceeding a pre-set threshold value.

15. The method of claim 14, further comprising, responsive to the at least one value of the incoming sensory data deviating from the value of the previous sensory data by the margin exceeding the pre-set threshold value, generating an updated feature vector based on the incoming sensory data and generate the assets' deployment plan based on at least one asset allocation parameter produced by the predictive model in response to the updated feature vector.

16. The method of claim 11, further comprising recording the asset allocation parameters on a blockchain ledger along with the key features retrieved from the sensory data and corresponding available fire suppression assets'-related data.

17. A non-transitory computer readable medium comprising instructions, that when read by a processor, cause the processor to perform:
acquiring sensory data from a plurality of sensors hosted on the at least one fire surveillance device;
parsing the sensory data to derive a plurality of key features;
acquiring available fire suppression assets'-related data from a local storage;
querying a local fires'-related database to retrieve local historical fires'-related data related to previous fires' suppression engagements based on the plurality of the key features and the available fire suppression assets'-related data;
generating at least one feature vector based on the plurality of key features, the available fire suppression assets'-related data and the local historical fires'-related data; and
providing the at least one feature vector to a machine learning module configured to generate a predictive model for producing asset allocation parameters for generation of the assets' deployment plan for the at least one least one command-and-control entity node.

18. The non-transitory computer readable medium of claim 17, further comprising instructions, that when read by the processor, cause the processor to continuously monitor incoming sensory data to determine if at least one value of the incoming sensory data deviates from a value of previous sensory data by a margin exceeding a pre-set threshold value.

19. The non-transitory computer readable medium of claim 18, further comprising instructions, that when read by the processor, cause the processor to, responsive to the at least one value of the incoming sensory data deviating from the value of the previous sensory data by the margin exceeding the pre-set threshold value, generate an updated feature vector based on the incoming sensory data and generate the assets' deployment plan based on at least one asset allocation parameter produced by the predictive model in response to the updated feature vector.

20. The non-transitory computer readable medium of claim 17, further comprising instructions, that when read by the processor, cause the processor to record the asset allocation parameters on a blockchain ledger along with the key features retrieved from the sensory data and corresponding available fire suppression assets'-related data.
